(19) United States
(12) Patent Application Publication
(10) Pub. No.: US 2018/0170116 A1
(43) Pub. Date: Jun. 21, 2018

(54) PNEUMATIC VEHICLE TIRE

(71) Applicant: Continental Reifen Deutschland GmbH, Hannover (DE)

(72) Inventor: Ronald Daries, Hannover (DE)

(21) Appl. No.: 15/895,887

(22) Filed: Feb. 13, 2018

Related U.S. Application Data
(63) Continuation of application No. PCT/EP2016/061868, filed on May 26, 2016.

(30) Foreign Application Priority Data
Aug. 13, 2015 (DE) 102015215455.6

(51) Int. Cl. B60C 11/13; B60C 11/04; B60C 11/03

(52) U.S. Cl. CPC B60C 11/13; B60C 11/042; B60C 2011/0353; B60C 2011/0355; B60C 11/0309

(57) ABSTRACT

A pneumatic vehicle tire for utility vehicles has a profiled tread having two circumferential ribs that are adjacent and are separated by a circumferential groove of depth H formed from radially inner and outer extension sections of height H₁ and H₂. The groove in the radially inner extension section is a channel of height H₁ and breadth B₁, and in the outer extension section is configured, along its circumferential extent, with an alternating sequence of first and second circumferential regions. The two flanks in the first regions are each configured, in the transition to the outer surface of the rib, with a chamfer of height H₄ such that H₄<H₂, and are spaced by a distance B₂ along their radial extent in the outer extension section from radially inward to radially outward as far as the chamfer.

### CROSS REFERENCE TO RELATED APPLICATIONS

This application is a continuation application of international patent application PCT/EP2016/061868, filed May 26, 2016, designating the United States and claiming priority from German application 10 2015 215 455.6, filed Aug. 13, 2015, and the entire content of both applications is incorporated herein by reference.

### FIELD OF THE INVENTION

The invention relates to a pneumatic vehicle tire for utility vehicles having a profiled tread having at least two circumferential ribs that are adjacent in the axial direction A and are separated by a circumferential groove of depth H measured in the radial direction R, wherein the circumferential groove is delimited in the axial direction A by two groove walls, wherein the circumferential ribs are outwardly delimited in the radial direction R by a radially outer surface forming the road contact surface, and in the axial direction toward the circumferential groove by a respective flank that forms a groove wall of the circumferential groove oriented toward the circumferential rib, and wherein the circumferential groove is formed from a radially inner extension section of height H₁ measured in the radial direction and, adjoining the latter radially, a radially outer extension section of height H₂, wherein the circumferential groove in the radially inner extension section is configured as a channel of height H₁ and breadth B₁ measured in the axial direction and extending over the entire circumference of the tire, wherein the radially outer extension section of the circumferential groove is configured, along its extent in the circumferential direction U, with an alternating sequence of first circumferential regions and second circumferential regions over the circumference, wherein the radially outer extension section of the circumferential groove is configured with a maximum breadth B₃ in the second circumferential regions such that B₃≥B₁ and with a breadth B₂ in the first circumferential regions along its extent in the circumferential direction such that B₂<B₁.

### BACKGROUND OF THE INVENTION

It is known to configure utility vehicle tires with circumferential ribs which are separated from one another in the axial direction of the tire by circumferential grooves. In that context, the circumferential grooves generally have, over the entire circumference of the tire, in each case in the cross-sectional planes that contain the tire axis, a cross-intersection contour that widens in a V shape from radially inward to radially outward, with groove walls that are straight over the entire radial extent. On one hand, these conventional grooves, and the large profile void ratio that they generate in the profile, make it possible to take up and remove a large amount of water. On the other hand, however, this large void ratio also has a negative effect on the rolling resistance of such utility vehicle tires. Although gripping edges are provided in the axial direction by the groove walls, none are provided in the circumferential direction. This reduces grip on snow-covered roads.

It has occasionally been proposed to configure the circumferential grooves, over the entire circumference of the pneumatic vehicle tire and in the cross-sectional planes that each contain the tire axis, as a radially inner extension section and a radially outer extension section, wherein the radially inner extension section is configured as a channel extending over the circumference of the tire and having a channel breadth that is constant over the entire circumference, and wherein the radially outer extension section is configured as a narrow circumferential groove which, along the entire extent over the circumference, is configured with a groove breadth that is narrower than the channel breadth. This configuration allows the removal of water that has penetrated into the profile, via the broad channel below the radially outer extension section. In that context, the radially outer extension section, by virtue of its smaller groove breadth in comparison to the conventional grooves, forms a smaller profile void ratio thus permitting an improvement in the rolling resistance. However, as these grooves pass through the contact patch while the tire rolls during driving, the radially outer extension section configured as a narrow groove can close slightly, thus preventing water from entering. This in turn impairs the wet properties of the tire. Furthermore, the repeated closing of the groove in the contact patch during rolling makes it easier for stones to be picked up and to enter the groove, and makes it more difficult for stones that have entered to be thrown loose. Closing the groove over the circumference does away with any grip edges, thus reducing grip on snow-covered roads.

U.S. Pat. No. 2,322,505 discloses configuring pneumatic vehicle tires with a tread profile. This known pneumatic vehicle tire makes it possible, even when passing through the contact patch, for water to enter the channel through the broad circumferential extension sections of the radially outer extension section, and the broad circumferential extension sections allow stones that have entered the profile to be more easily ejected from the tread profile.

However, the circumferential groove, in the extension region of the first circumferential regions in which it is narrow, can still close slightly as it passes through the contact patch so that the penetration of water and the removal of water via the circumference of the tire is still greatly prevented. When driving over snow-covered surfaces, the closing of the grooves in the region of the contact patch forms an apparently smooth surface with no further gripping edges. Thus, the grip properties of this tire in wet and snowy conditions are still greatly limited.

In the configuration known from this document, the circumferential groove in the outer extension region is configured with reduced radial stiffness in the radially outer extension section owing to the annular channel that is very broad in the narrow extension sections of the groove, which reduced radial stiffness makes it possible to be pushed open as it passes through the contact patch owing to the water pressure when a high water pressure is built up. This has a negative effect on the rolling resistance and in turn allows stones to enter the narrow extension section of the groove.

### SUMMARY OF THE INVENTION

It is an object of the invention to provide a pneumatic vehicle tire for utility vehicle tires in which improved rolling resistance is made possible alongside improved wet properties and good stone-catching properties.

The object can, for example, be achieved via a pneumatic vehicle tire for utility vehicles having a profiled tread including at least two circumferential ribs that are adjacent in the axial direction A and are separated by a circumferential groove of depth H measured in the radial direction R, wherein the circumferential groove is delimited in the axial direction A by two groove walls, wherein the circumferential ribs are outwardly delimited in the radial direction R by a radially outer surface forming the road contact surface, and in the axial direction A toward the circumferential groove by a respective flank that forms a groove wall of the circumferential groove oriented toward the circumferential rib, and wherein the circumferential groove is formed from a radially inner extension section of height H₁ measured in the radial direction and, adjoining the latter radially, a radially outer extension section of height H₂, wherein the circumferential groove in the radially inner extension section is configured as a channel of height H₁ and breadth B₁ measured in the axial direction and extending over the entire circumference of the tire, wherein the radially outer extension section of the circumferential groove is configured, along its extent in the circumferential direction U, with an alternating sequence of first circumferential regions and second circumferential regions over the circumference, wherein the radially outer extension section of the circumferential groove is configured with a maximum breadth B₃ in the second circumferential regions such that B₃≥B₁ and with a breadth B₂ in the first circumferential regions along its extent in the circumferential direction such that B₂<B₁, in which the two flanks in the first circumferential regions, which form the groove walls, are configured, in the transition to the radially outer surface of the circumferential rib, with in each case a chamfer of height H₄ measured in the radial direction R such that H₄<H₂, and are spaced apart from one another by a distance B₂ along their radial extent in the radially outer extension section from radially inner to radially outer as far as the chamfer.

This configuration makes it possible to have a small void ratio in the radially outer surface while having a large take-up and discharge volume of water. This makes it possible to use the low void ratio configuration, which is advantageous for rolling resistance, while at the same time being able to take up large volumes of water. Furthermore, this configuration means that, in passing through the contact patch while the tire rolls, water can easily flow in and out through the broad second circumferential regions, and also any stones that have been picked up can more easily be thrown out. Furthermore, as the contact patch proceeds, another through-flow channel through which the water can be taken up and conveyed is held open in the first circumferential region—even when the groove closes—by virtue of the configuration of the two groove walls with a chamfer between the road and the two chamfers. This makes it possible to counteract a build-up of high water pressure. This reduces the possibility of high water pressure opening or partially opening the circumferential section that is closed in the contact patch. This has a positive effect on low rolling resistance. This also impedes penetration of stones into the first circumferential regions when passing through the contact patch. In addition, the chamfers provide edges for improved grip on snow and wet surfaces, in spite of the first extension regions closing when passing through the contact patch. In a further embodiment, the breadth B₂ is configured such that 2.5 mm≤B₂≤3 mm. This makes it easily possible to implement a particularly take-up of water in the first circumferential section outside the contact patch with reliable closing of the first circumferential section in the contact patch and thus—in spite of particularly good take-up of water—to bring about particularly favorable rolling resistance.

In an embodiment the breadth B₁ is configured such that 5 mm≤B₂≤10 mm and the height H₁ is configured such that (⅓)H≤H₁≤(⅔)H. This makes it possible, in a simple manner and in spite of a low void fraction that is desired for lower rolling resistance, to provide a sufficiently large, effective channel for removal of water without buckling of the radially outer extension section of the first circumferential extension regions on closing of the groove when passing through the contact patch, which is not desired for good rolling resistance.

In an embodiment the breadth B₃ is configured such that B₃≤17 mm. This makes it possible to further reduce the void fraction of the profile and thus to further promote good rolling resistance. In an embodiment the height H₂ is configured such that (⅓)H≤H₂≤(⅔)H. This makes it possible, in a simple manner, to permit a high supporting effect of the first circumferential region that is closed in the contact patch, and thus to reliably counteract an undesired. This further favors good rolling resistance.

In an embodiment the height H is configured such that 8 mm≤H₁≤18 mm. This makes it possible to further positively influence the rolling resistance.

In an embodiment the height H₄ is configured such that 1 mm≤H₄≤3 mm. This means that the height H₄ is chosen to be sufficiently large to reliably “cut” through the water film, and to simply bring about sufficient take-up capacity between the chamfers of the two groove walls, and sufficiently small to not impair the stability of the circumferential section that is closed in the contact patch, and thus to bring about particularly good rolling resistance.

In an embodiment, in the second circumferential regions, the intersection contour of the two groove walls and the radially outer surface together respectively form three sides and four vertices of a shared, symmetric octagon. This makes it possible, in a simple manner, to bring about an orientation, optimized for noise reduction, of the edges in the radially outer surface of the second circumferential section that are active when rolling on the road, and thus to permit noise optimization. In an embodiment, in the radially inner extension section in the cross-sectional planes containing the tire axis, the groove walls are configured to be spread apart in a V shape from radially inner to radially outer, enclosing an opening angle β such that 4°≤β≤40°. This configuration makes it possible, in a simple manner, to make stone capture more difficult and to promote the ejection of captured stones, and to counteract the formation of stress concentrations during driving in the transition between the groove bottom and the groove wall and thus to counteract crack formation and thereby reliably bring about closure of the groove in the radially outer extension section of the first circumferential extension regions without buckling when passing through the contact patch, which is undesirable for good rolling resistance.

In an embodiment, in the radially inner extension section, the groove is bounded radially inwardly by a groove bottom which bounds the groove and has breadth B₅ such that 4 mm≤B₅≤B₁.

In an embodiment, in the second circumferential regions, at least in each central circumferential extension region over the radial extent from the inner and radially outer extension section and as far as the radially outer surface, and in the cross-sectional planes containing the tire axis, the groove walls are configured to be straight and to be spread apart in a V shape from radially inner to radially outer, enclosing an opening angle β such that 4°≤β≤40°, and to be at a distance B₃ from one another at the radially outer surface. This configuration makes it possible, in a simple manner, to make stone capture more difficult and to promote the ejection of captured stones. It is also possible to counteract the formation of stress concentrations during driving in the transition between the groove bottom and the groove wall and thus to counteract crack formation.

### BRIEF DESCRIPTION OF THE DRAWINGS

The invention will now be described with reference to the drawings wherein:

FIG. 1 shows a circumferential extension section of a tread profile of a utility vehicle tire in plan view;

FIG. 2 is an enlarged detail of the tread profile of FIG. 1 in plan view for the purpose of illustrating the configuration of a circumferential groove;

FIG. 3 shows the circumferential groove of FIG. 2 in a section view through line III-III of FIG. 2;

FIG. 4 shows the circumferential groove of FIG. 2 in a section view through line IV-IV; and,

FIG. 5 shows the circumferential groove of FIG. 2 in a section view through line V-V of FIG. 2.

### DESCRIPTION OF THE PREFERRED EMBODIMENTS OF THE INVENTION

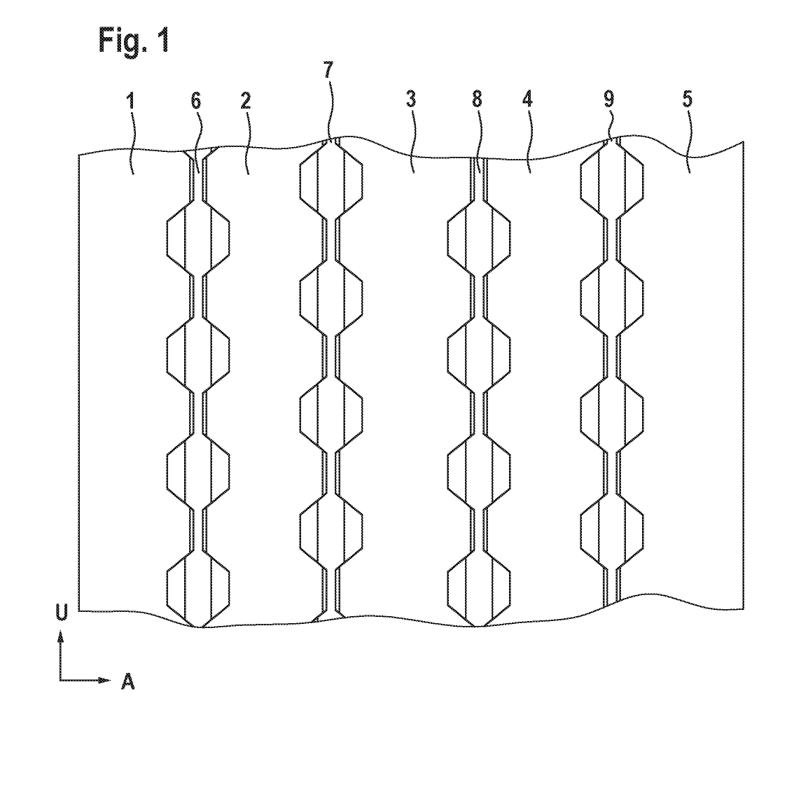

FIG. 1 shows a tread profile of a pneumatic vehicle tire for utility vehicles, with multiple circumferential ribs 1, 2, 3, 4 and 5 which are arranged adjacent to one another in an axial direction A of the pneumatic vehicle tire and which extend over the circumference of the pneumatic vehicle tire and which are oriented in a circumferential direction U.

In that context, circumferential ribs which are arranged axially adjacent to one another are in each case separated axially from one another by a circumferential groove. The circumferential ribs 1 and 2 are spaced apart from one another in the axial direction A by a circumferential groove 6 which extends over the entire circumference of the pneumatic vehicle tire and which is oriented in the circumferential direction U of the pneumatic vehicle tire. The circumferential ribs 2 and 3 are spaced apart from one another in the axial direction A by a circumferential groove 7 which extends over the entire circumference of the pneumatic vehicle tire and which is oriented in the circumferential direction U of the pneumatic vehicle tire. The circumferential ribs 3 and 4 are spaced apart from one another in the axial direction A by a circumferential groove 8 which extends over the entire circumference of the pneumatic vehicle tire and which is oriented in the circumferential direction U. The circumferential ribs 4 and 5 are spaced apart from one another in the axial direction A by a circumferential groove 9 which extends over the entire circumference of the pneumatic vehicle tire and which is oriented in the circumferential direction U. The circumferential ribs 1 and 5 are shoulder ribs.

The circumferential ribs 1, 2, 3, 4 and 5 are delimited toward the outside in the radial direction R of the pneumatic vehicle tire by a radially outer surface 19 which forms the road contact surface. The circumferential grooves 6, 7, 8 and 9 are delimited inwardly in the radial direction R by a groove bottom 14 which extends over the entire circumference of the pneumatic vehicle tire. The circumferential ribs 1, 2, 3, 4 and 5 are delimited in the axial direction A toward the respectively adjoining circumferential groove by a flank which forms the groove wall, respectively oriented toward the circumferential rib, of the associated circumferential groove.

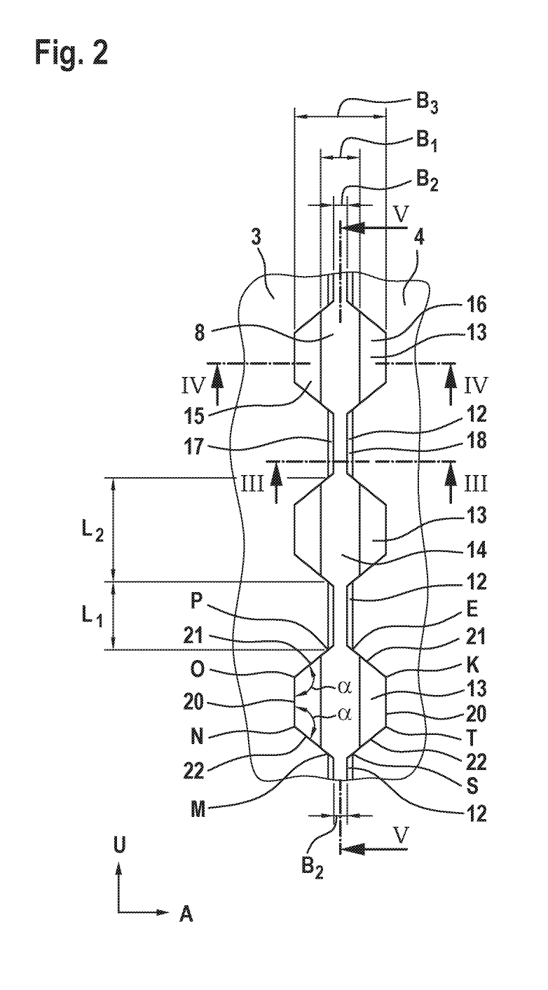

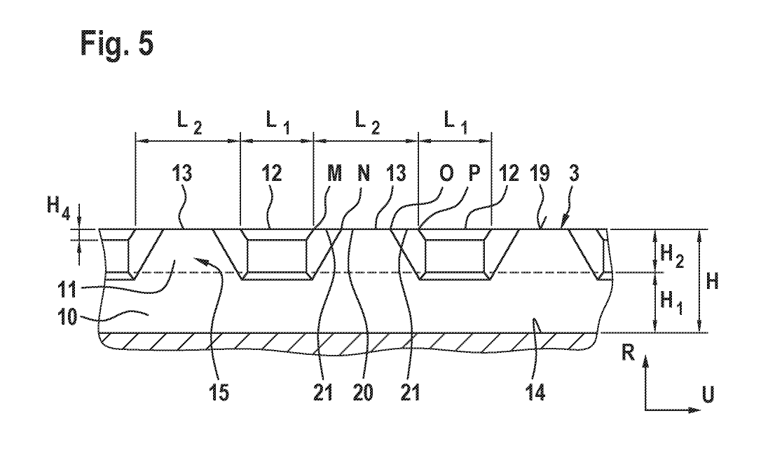

FIGS. 2 to 5 illustrate the configuration of the circumferential grooves 6, 7, 8 and 9 in greater detail using the example of the circumferential groove 8. These figures show that the circumferential rib 3 bounding the circumferential groove 8 is bounded on its side facing the circumferential groove 8 by a flank 15 which extends in the radial direction R from the groove bottom 14 of the circumferential groove 8 to the radially outer surface 19 of the circumferential rib 3 and so forms the groove wall, facing the circumferential rib 3, of the circumferential groove 8. The circumferential rib 4 is bounded on its side facing the circumferential groove 8 in the axial direction A by a flank 16 which extends in the radial direction R from the groove bottom 14 to the radially outer surface 19 of the circumferential rib 4 and so forms the groove wall, facing the circumferential rib 4, of the circumferential groove 8. The circumferential groove 8 is configured with a groove depth H measured, in the radial direction R, from the radially outer surface 19 of the adjacent circumferential ribs 3 and 4 inward to the groove bottom 14. The groove bottom 14 of the circumferential groove 8 is configured with a breadth B₅ measured in the axial direction A of the pneumatic vehicle tire.

The circumferential groove 8 consists, in the radial direction R, of a radially inner extension section 10 and a radially outer extension section 11. The radially inner extension section 10 extends outward in the radial direction R from the groove bottom 14 to an extension height H₁ measured radially outwardly in the radial direction R from the groove bottom 14. Adjoining the radially inner extension section 10, the radially outer extension section 11 extends with an extension height H₂, measured in the radial direction R, to the radially outer surface 19. In the radially inner extension section 10, the circumferential groove 8 is configured over the circumference of the pneumatic vehicle tire as a throughflow channel 10, oriented in the circumferential direction U and extending over the circumference of the tire and having extension height H₁ and channel breadth B₁.

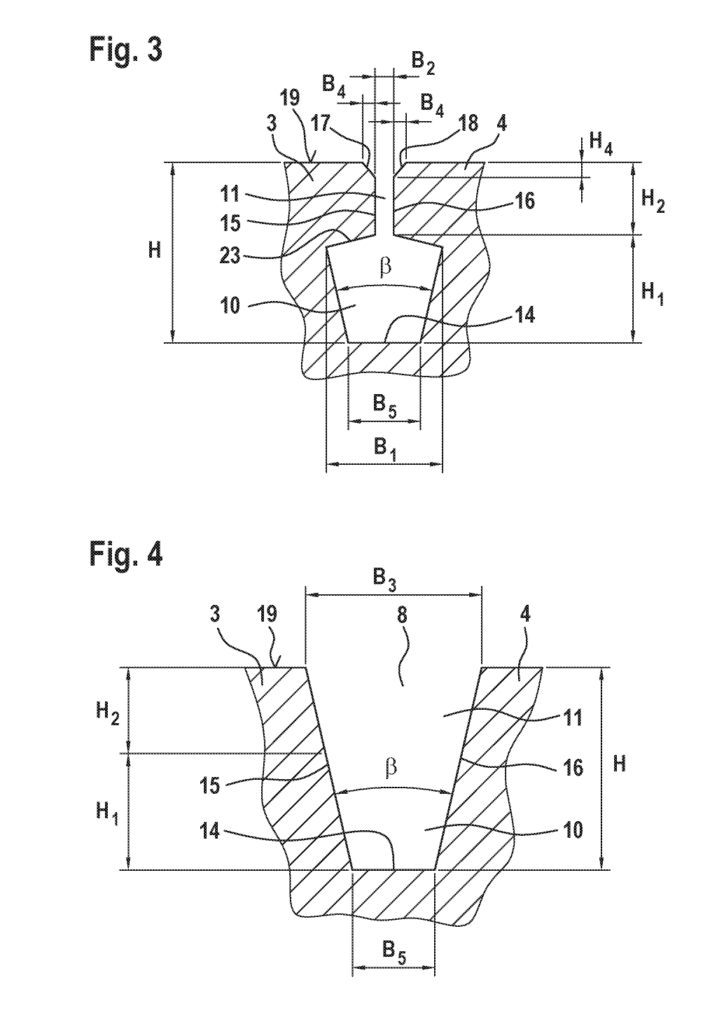

The groove walls 15 and 16 in the radially inner extension section 11 in the cross-sectional planes of the tire which contain the tire axis—as shown in FIGS. 3 and 4—in each case configured inclined along their radial extent from inside to outside, in each case in the axial direction A, with respect to the circumferential rib 3 or 4 that is to be assigned to the respective groove wall 15 or 16. In that context, the groove walls 15 and 16 enclose, with one another, and opening angle β where 4°≤β≤40°, for example β=5°.

As seen over the entire circumference of the tire and in all cross-sectional planes that contain the tire axis, the groove walls 15 and 16, in the radially inner extension section 11, are configured with a distance with respect to one another that increases continuously in the radially outward direction R proceeding from the groove bottom 14, respectively enclosing the angle of inclination β, and reach their maximum separation B₁, measured in the axial direction A, in the region of the radial extension end of the radially inner extension section 10.

In the radially outer extension section 11, the circumferential groove 8 is configured, along its extent in the circumferential direction U over the circumference of the tire, as an alternating sequence, arranged in series, of circumferential extension regions 12 of narrow groove breadth and circumferential extension regions 13 of large groove breadth. In the circumferential extension regions 12, the circumferential groove 8, in the radially outer extension section 11 along its extent in the circumferential direction U and along its radial extent R proceeding from the transition from the radially inner extension section 10 to the radially outer extension section 11, is configured in the radial direction to the radially outer surface 19 with a constant groove breadth B₂, where B₂<B₁.

In the transition to the radially outer surface 19 of the circumferential rib 3, the flank 15 is configured with a chamfer 17 in the entire circumferential extension region 12. Also, in the transition to the radially outer surface 19 of the circumferential rib 4, the flank 16 is configured as a chamfer 18 in the entire circumferential extension region 12. The chamfers 17 and 18 extend in the radial direction R over an extension height H₄.

As shown in FIG. 3, the flank 15 extends into the cross-sectional planes that contain the tire axis, in the radially inner extension section 10 proceeding from the radial position having the larger breadth B₁ in an extension section in the axial direction A inwardly toward the other flank 16. The flank 16 also extends from the radial position of breadth B₁ in an extension section in the axial direction A inwardly toward the other flank 15. In the extension section 23, the flanks 15 and 16 respectively form an axially inward axial setback of the flank 15 or 16. In that context, they respectively form, with their setback, a radially outwardly oriented closure face 23 of the radially inner extension section H₁ and of the through-flow channel. As shown in FIG. 3, production dictates that this closure face 23 be inclined along its extent in the axial direction A, with a minor radial gradient. In that context, the flanks 15 and 16 extend toward one another in the axial direction A, forming the closure faces 23, as far as a separation B₂ from one another that they adopt in a position at a radial distance H₂ from the radially outer surface 19. From this position, the flanks 15 and 16 extend radially outward at the distance B₂ from one another and form the radially outer extension section 11 having extension height H₂.

In the circumferential extension sections 14, the circumferential groove 8—as shown in FIG. 4—is configured also in the radially outer extension section 11 having extension height H₂ with a breadth increasing from inside to outside along its radial extent, and reaches its maximum breadth B₃ in the position of the radially outer surface 19 of the circumferential ribs 3 and 4, where B₃>B₁. In that context, B₃ is chosen such that B₃≤17 mm. In that context, the circumferential groove 8, in its substantial circumferential extension section of the circumferential extension region 13—as shown in FIG. 4—proceeding from the groove bottom 14 over the radially inner extension section H₁ and the adjacent radially outer extension section H₂, and thus over the entire groove depth H, is configured, in those cross-sectional planes that contain the tire axis, with a straight intersection contour of the flank 15 and with a straight intersection contour of the flank 16, and thus so as to enclose the opening angle β.

As shown in FIG. 2, the flank 15 intersects the radially outer surface 19 of the circumferential rib 3 in an intersection contour which is oriented over the basic, central extension region 20 of the circumferential extension section 13 in the circumferential direction U of the pneumatic vehicle tire. The intersection contour of the circumferential extension section 14 with the radially outer surface 19 of the circumferential rib 3 is configured from this central extension section 20, a transition extension section 22 arranged immediately in front of this central extension section 20 in the circumferential direction U and a transition extension section 21 arranged immediately behind this central extension section 20 in the circumferential direction U. The transition extension section 21 connects the intersection contour of the flank 15 with the radially outer surface 19 of the basic, central extension region 20 with the intersection contour of the flank 15 with the radially outer surface 19 of the circumferential extension region 12 immediately subsequent in the circumferential direction U. The transition extension section 22 connects the intersection contour of the flank 15 with the radially outer surface 19 of the basic, central extension region 20 with the intersection contour of the flank 15 with the radially outer surface 19 of the circumferential extension region 12 immediately preceding in the circumferential direction U.

In the radially outer surface, the intersection contour in the central extension section 20—as shown in FIG. 2—extends between two points N and O. The intersection contour of the extension section 21 which extends up to a point P adjoins at point O. The intersection contour linear profile of the subsequent circumferential extension section 12 adjoins at point P. The intersection contour of the extension section 22 which extends up to a point M adjoins the intersection contour of the extension section 20 at point N. The intersection contour linear profile of the preceding circumferential extension section 12 adjoins at point M.

Similarly, the flank 16 intersects the radially outer surface 19 of the circumferential rib 4 in an intersection contour which is oriented over the basic, central extension region 20 of the circumferential extension section 13 in the circumferential direction U of the pneumatic vehicle tire. The intersection contour of the circumferential extension section 14 with the radially outer surface 19 of the circumferential rib 4 is configured from this central extension section 20, a transition extension section 22 arranged immediately in front of this central extension section 20 in the circumferential direction U and a transition extension section 21 arranged immediately behind this central extension section 20 in the circumferential direction U. The transition extension section 21 connects the intersection contour of the flank 16 with the radially outer surface 19 of the basic, central extension region 20 with the intersection contour of the flank 16 with the radially outer surface 19 of the circumferential extension region 12 immediately subsequent in the circumferential direction U. The transition extension section 22 connects the intersection contour of the flank 16 with the radially outer surface 19 of the basic, central extension region 20 with the intersection contour of the flank 16 with the radially outer surface 19 of the circumferential extension region 12 immediately preceding in the circumferential direction U.

In the radially outer surface, the intersection contour in the central extension section 20—as shown in FIG. 2—extends between two points T and K. The intersection contour of the extension section 21 which extends up to a point E adjoins at point K. The intersection contour linear profile of the subsequent circumferential extension section 12 adjoins at point E. The intersection contour of the extension section 22 which extends up to a point S adjoins the intersection contour of the extension section 20 at point T. The intersection contour linear profile of the preceding circumferential extension section 12 adjoins at point S.

Points M, N, O, P, E, K, T and S form, in the radially outer surface 19, points of an octagon that is symmetric with respect to the center line of the circumferential groove 8 formed in the circumferential direction U in the radially outer surface 19. In that context, the intersection contour of the central extension section 20 of the flank 15, together with the radially outer surface 19, forms the side NO of the octagon. The intersection contour of the extension section 21 of the flank 15, together with the radially outer surface 19, forms the side OP of the octagon. The intersection contour of the extension section 22 of the flank 15, together with the radially outer surface 19, forms the side NM of the octagon. The intersection contour of the extension section 20 of the flank 16, together with the radially outer surface 19, forms the side TK of the octagon. The intersection contour of the extension section 21 of the flank 16, together with the radially outer surface 19, forms the side KE of the octagon. The intersection contour of the extension section 22 of the flank 16, together with the radially outer surface 19, forms the side ST of the octagon. Across the circumferential groove 8, the line connecting points P and E forms the side PE of the octagon and the line connecting points M and S forms the side MS of the octagon.

In the radially outer surface 19, the sides OP and ON enclose an internal angle α. The sides ON and NM also enclose an internal angle α in the radially outer surface 19. The side KE and the side KT also enclose an internal angle α in the radially outer surface 19. The sides KT and TS also enclose an internal angle α. In that context, the angle α is configured such that 100°≤α≤140°.

In the embodiment shown, the sides NO, OP and MN are respectively chosen to have the same length. The sides TK, KE and TS are also respectively chosen to have the same length.

Along the extension of the sides NO and TK, and thus over at least half of the extension length L₂, the flanks 15 and 16 thus respectively extend—as shown in FIG. 4—with an intersection line contour that is straight in the cross-sectional planes that contain the tire axis, proceeding from the groove bottom 14 to the radially outer surface 19. Along the circumferential extension sections of sides OP or MN or EK or TS, the flanks 15 and 16 extend, in the cross-sectional planes that contain the tire axis, from the groove bottom 14 through the entire radial inner extension section 10 having height H₁, continuing in a straight line as far as the radially outer extension section 11 and then transition, including a kink, into a straight, radial extension section.

The breadth B₁ is 5 mm≤B₁≤10 mm, for example B₁=7 mm. The breadth B₂ is 2.5 mm≤B₂≤3 mm, for example B₂=3 mm. The breadth B₅ of the groove bottom 14 is 4 mm≤B₅≤B₁. For example, B₅=4 mm.

The height H is 8 mm≤H≤18 mm. The height H₁ is (⅓)H≤H₁≤(⅔)H. The height H₂ is (⅓)H≤H₂≤(⅔)H.

The height H₄ is 1 mm≤H₄≤3 mm.

For example, H=12 mm, H₁=6 mm, H₂=6 mm and H₄=2 mm.

The circumferential extension regions 12 are in each case configured, as seen in the circumferential direction U in the radially outer surface, with an extension length L₁ and the circumferential extension regions 13 with an extension length L₂, where L₁≤L₂≤2L₁. For example, L₂=1.5 L₁.

L₁ is 10 mm≤L₁≤50 mm.

In the radially inner extension section 10, the circumferential groove 8 is configured as a channel which extends over the entire circumference of the tire and which, in the circumferential extension sections 12, is bounded radially inwardly by the groove bottom 14 and radially outwardly by the covering faces 23 formed by the groove flanks, and in the axial direction A by those two sections of the flanks 15 and 16 that widen in a V shape between the groove bottom 14 and the covering faces 23. In the circumferential extension regions 13, the channel formed in the radially inner extension section is bounded radially inwardly by the groove bottom 14, in the axial direction A by the two flanks 15 and 16 that widen in a V shape, and is open radially outwardly.

As shown in FIG. 1, the configuration of circumferential grooves 6, 7 and 9 is analogous with that of circumferential groove 8.

In that context, FIG. 1 shows another embodiment in which, in the circumferential grooves 7 and 9, the circumferential position of the extension sections 13 is positioned between the circumferential positions of the extension sections 13 of circumferential groove 8.

It is understood that the foregoing description is that of the preferred embodiments of the invention and that various changes and modifications may be made thereto without departing from the spirit and scope of the invention as defined in the appended claims.

### LIST OF REFERENCE SIGNS

### (Part of the Description)

1 Circumferential rib

2 Circumferential rib

3 Circumferential rib

4 Circumferential rib

5 Circumferential rib

6 Circumferential groove

7 Circumferential groove

8 Circumferential groove

9 Circumferential groove

10 Radially inner extension section

11 Radially outer extension section

12 Narrow circumferential region

13 Broad circumferential region

14 Groove bottom

15 Flank

16 Flank

17 Chamfer

18 Chamfer

19 Radially outer surface

20 Central circumferential extension section

21 Transition extension section

22 Transition extension section

23 Closure face

What is claimed is:

1. A pneumatic vehicle tire for utility vehicles, the pneumatic vehicle tire comprising:
a profiled tread;
the pneumatic vehicle tire defining a tire circumference, a radial direction R, an axial direction A, and a circumferential direction U;
said profiled tread having at least two circumferential ribs that are adjacent in the axial direction A and are separated by a circumferential groove having a depth H measured in the radial direction R;
said circumferential groove being delimited in the axial direction A by two groove walls;
said circumferential ribs being outwardly delimited in the radial direction R by a radially outer surface forming a road contact surface, and in the axial direction A toward said circumferential groove by a corresponding flank that forms a corresponding one of said two groove walls oriented toward the corresponding one of said circumferential ribs;
said circumferential groove being formed from a radially inner extension section having a height H₁ measured in the radial direction and, adjoining the latter radially, a radially outer extension section having height H₂;
said circumferential groove in said radially inner extension section being configured as a channel having a height H₁ and a breadth B₁ measured in the axial direction A and extending over the entirety of the tire circumference;
said radially outer extension section of said circumferential groove being configured, along its extent in the circumferential direction U, with an alternating sequence of first circumferential regions and second circumferential regions over the tire circumference;
said radially outer extension section of said circumferential groove being configured with a maximum breadth B₃ in said second circumferential regions such that B₃≥B₁ and with a breadth B₂ in said first circumferential regions along its extent in the circumferential direction U such that B₂<B₁;
said two flanks which form said groove walls, in said first circumferential regions, each have, in a transition to said radially outer surface of said circumferential rib, a chamfer having a height H₄ measured in the radial direction R such that H₄<H₂; and,
said two flanks are spaced apart from one another by a distance B₂ along their radial extent in said radially outer extension section from radially inwardly to radially outwardly as far as said chamfer.

2. The pneumatic vehicle tire of claim 1, wherein said breadth B₂ is such that 2.5 mm≤B₂≤3 mm.

3. The pneumatic vehicle tire of claim 1, wherein said breadth B₁ is such that 5 mm≤B₁≤10 mm and said height H₁ is such that (⅓)H≤H₁≤(⅔)H.

4. The pneumatic vehicle tire of claim 1, wherein said breadth B₃ is such that B₃≤17 mm.

5. The pneumatic vehicle tire of claim 1, wherein said height H₂ is such that (⅓)H≤H₂≤⅔)H.

6. The pneumatic vehicle tire of claim 1, wherein said height H₁ is such that 8 mm≤H₁≤18 mm.

7. The pneumatic vehicle tire of claim 1, wherein said height H₄ is such that 1 mm≤H₄≤3 mm.

8. The pneumatic vehicle tire of claim 1, wherein, in said second circumferential regions, an intersection contour of said two groove walls and said radially outer surface together respectively form three sides and four vertices of a shared, symmetric octagon.

9. The pneumatic vehicle tire of claim 1, wherein, in said radially inner extension section cross-sectional planes containing the tire axis, said groove walls are straight and spread apart in a V shape from radially inwardly to radially outwardly, enclosing an opening angle β such that 4°≤β≤40°.

10. The pneumatic vehicle tire of claim 9, wherein, in said radially inner extension section, said circumferential groove is bounded radially inwardly by a groove base having a breadth B₅ such that 4 mm≤B₅≤B₁.

11. The pneumatic vehicle tire of claim 9, wherein, in said second circumferential regions, at least in corresponding central circumferential extension regions thereof, over the radial extent from said radially inner extension section and radially outer extension section and as far as said radially outer surface, and in cross-sectional planes containing a tire axis, said groove walls are configured to be straight and to be spread apart in a V shape from radially inwardly to radially outwardly, enclosing an opening angle β such that 4°≤β≤40°, and to be at a distance B₃ from one another at said radially outer surface.
